(19) United States
(12) Patent Application Publication
(10) Pub. No.: US 2008/0101152 A1
(43) Pub. Date: May 1, 2008

(54) Transport Device For Bulk Material

(75) Inventors: Franz Josef Zellerhoff, Paderborn (DE); Frank Eric Sandfort, Paderborn (DE)

Correspondence Address: RANKIN, HILL & CLARK LLP, 925 EUCLID AVENUE, SUITE 700, CLEVELAND, OH, 44115-1405, US

(73) Assignee: Gebr. Lodige Maschinenbau GmbH, Paderborn (DE)

(21) Appl. No.: 11/877,766

(22) Filed: Oct. 24, 2007

(30) Foreign Application Priority Data
Oct. 31, 2006 (DE) 102006051871.3

(51) Int. Cl. B01F 15/00; B01F 15/02; B01F 15/04; B28C 7/04

(52) U.S. Cl. 366/16; 366/141; 366/142; 366/160.1; 366/186; 366/190

(57) ABSTRACT

The invention relates to a transport device for bulk material, comprising a mixer, a feed for bulk material and a feed for liquid into the mixer, and means for withdrawing mixing material from the mixer and to preferably transport it further via pipelines, i.e. in particular with a pump.

The invention relates to a device for being able to transport bulk material over many kilometers.

Within the sense of the invention, bulk material is, for example, sand. In the prior art, sand is, for example, transported by means of freight vehicles.

Bulk material is to be transported in another way by means of the present invention.

In order to solve the object, bulk material is mixed with a liquid in a mixer and thus transferred into a pumpable state. The mixture is delivered by means of a pump via pipelines to its destination.

Maintaining a uniform delivery pressure poses a problem in such a transport over many kilometers. It is not a problem to have a pump pump in a uniform manner. However, ensuring that a pumpable mixture is properly available in a sufficient amount does present a problem.

In order to solve this problem, the components bulk material and liquid that are to be mixed are fed to a mixer. In the mixer, the components are mixed. A container or vessel is being made available containing material that is already mixed. The mixed material is pumped out of the container continuously in a constant quantity and passed on. The quantity of mixing material located in the container is continuously monitored, for example by weighing the container. It may be enough to monitor whether a specified minimum quantity as well as a specified maximum quantity of mixing material is in the container. The feed of components into the mixer is controlled depending on this monitoring. If the specified minimum quantity is about to under-run, the feed of components into the mixer is increased. If the maximum quantity is about to be exceeded, the feed of components into the mixer is reduced.

This is achieved in such a way that mixed material can be taken from the device in a continuous and uniform manner, independent from fluctuations in the feed of components of the mixing material to the mixer. It is thus possible to convert the mixing material into a pumpable condition and, at the same time, to ensure that the pumpable mixture can also be pumped through pipelines over many kilometers.

In one embodiment of the invention, there is a control apparatus ensuring that the ratio of the components fed to the mixer relative to one another is not changed. It is thus accomplished that the composition of the mixing material, which is or can be taken out of the device in a continuous and uniform manner, does not change. As a rule, this is important for the production processes.

In one embodiment, the components fed to the mixer comprise sand. Thus, this is not a pumpable solid. In order to provide a pumpable mixture, the sand is fed to the mixer together with a liquid, for example water, and optionally another required component.

If mixing material is processed in a quantity of, for example, 70 t per hour, then the proportion of water for providing a pumpable mixture is approximately 10 to 20 t. In this example, sand constitutes the main component of the mixture. In order to be able to set the correct ratio of the fed components, the main component is weighed during the feed to the mixer in one embodiment. Depending on this, the constituents to be admixed are fed, or the quantity to be fed is controlled. Thus, the control variable is the weight of the main component, for example sand, in the present case. This is used, for example, to control a dosing valve or a pump in order to thus control the liquid feed that is fed to the mixer as a further component. A constant composition of the mixing material is thus ensured, which further ensures in an improved manner that the bulk material can be transported in pipelines.

The bulk material, that is, in the present exemplary case, sand, is preferably transported via a conveyor belt. In one embodiment, the conveyor belt continuously passes the bulk material to a weighing belt. This may be, for example, 3 meters in length. This embodiment has the advantage that an interface is available, in contrast to other solutions in which a finished conveyor belt already comprises weighing sections. Thus, the device can be easily integrated into existing systems.

In one embodiment of the invention, there is a container subsequent to the mixer. It is established whether this container fills with mixing material or discharges it, or whether it maintains the container weight including the mixing material contained therein. Depending on this, it is ensured that more or less of the components is fed to the mixer in order to keep the container weight constant, if possible. If it is determined that a constant container weight cannot be achieved by such a readjustment, then the subsequent pump is controlled dependent thereon in one embodiment, that is, the pumping power is increased or decreased as necessary. However, this is not done dynamically, according to the invention. Instead, the pumping power is changed “once”. A constant quantity is conveyed before and after. It thus becomes possible to transport bulk material via pipelines, also over many kilometers.

In one embodiment of the invention, the upstream belt weigher, with which the bulk material is weighed, also serves the purpose of controlling the device such that the operation is stopped if it is found that the feed of mixing material fails to arrive.

If another powdered component is to be added into the mixer, apart from the bulk material and liquid, then this is preferably done via a screw. This feed makes possible a closed container in which the screw is accommodated. This counteracts a formation of dust. The delivery volume of the screw in this embodiment is controlled by means of the signal supplied from the weighing belt weighing the weight of the main component. In that case, the closed container is located on a subtraction scale. The subtraction scale subtracts the weight currently weighed from a reference value of the weight that was weighed shortly before. The typical time difference in the range of seconds. In this manner, the decrease or increase in weight is determined. At the same time, this is used to calculate how much can be conveyed in total per hour. It was originally known, as an input value, which total quantity was in the closed container initially. Thus, the information on what quantity is transported by means of the screw is available. This information is also required for keeping the composition fed to the mixer constant.

In the container from which the mixing material is passed to the pump, the mixing material is preferably withdrawn from underneath in order to ensure that, in that case, mixing material can always reach the pump if there is indeed mixing material in the container. In the process, there is, as a rule, the problem that a kind of funnel can be generated. The scale that acquires the content of the container then still indicates the presence of mixing material. However, mixing material cannot reach the pump anymore due to the funnel. In order to overcome this problem, it is ensured in one embodiment of the invention that a circulation within the container is generated. This is done, for example, by means of a twin screw. The twin screw prevents funnels from being generated if it is, for example, arranged horizontally on the bottom of the container.

In order to prevent the mixing material from being separated in the downstream container, a stirrer may additionally be provided in the container in one embodiment of the invention in order to prevent unmixing. Thus, the proper transport is ensured in an additionally improved manner.

In one embodiment of the invention, the mixer is the container whose content is monitored in order to control the feed of the components bulk material and liquid dependent thereon. This embodiment can be taken into consideration in the case of large-volume mixtures. In that case, the mixer itself is located on a scale. Otherwise, the method proceeds as described above.

On its inside, the mixer preferably has a rubber coating, preferably consisting of individual elements that can be secured by means of bolts. This makes it possible to replace the rubber coating easily. The rubber coating offers protection against wear.

The mixer blades are preferably formed to be particularly wear-resistant, namely by welding on hard metal. A hard metal is applied onto and embedded into the blades. Widia is, for example, used as a hard metal. Corundum is an alternative. Lining the drum on its surface with a steel of higher density in order to ensure a greater wear-resistance constitutes an alternative wear protection.

In one embodiment of the invention, the mixer, which preferably is a horizontal mixer, has a so-called baffle disc of the discharge passage. The baffle disc can be swiveled out of the mixer or into the mixer. It is able to change the discharge area of the mixer. In the case of a closed position of the disc, a degree of filling in the mixer is maintained. The degree of filing is changed by lowering the disc. The mixer can be opened completely by swiveling the disc away. Thus, it is possible to empty the mixer completely. The special feature is that the position of the baffle disc can be changed in the running operation. The filling capacity and the degree of filling can be influenced in the running operation. In this manner, wear can also be controlled and minimized. With this embodiment, the mixer can furthermore be cleaned particularly quickly.

The residence time in the mixer can be set by means of the baffle disc. If the feeding conditions of the mixing material change, then it can be ensured during the running operation, by means of the baffle disc, that a desired optimal degree of filling or a desired optimal residence time is complied with in order to thus minimize the wear, which in the present case in particular presents a problem if the mixing material comprises sand.

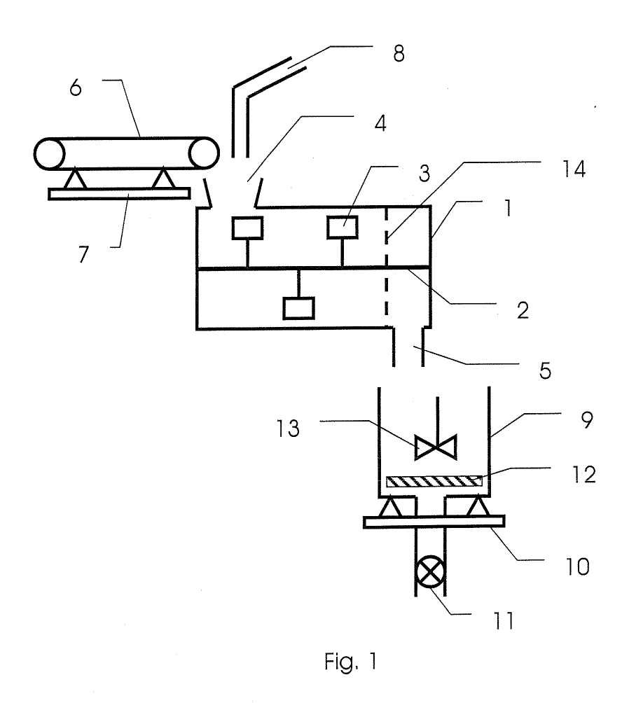

FIG. 1 illustrates an embodiment of the invention.

FIG. 1 shows a mixer 1 having a shaft 2 and stirring tools 3. The shaft is mounted horizontally. The mixer has a feed 4 located close to the one end of the mixer. A discharge passage 5 is arranged close to the other end of the mixer. A good thorough mixing of the mixing material is thus ensured.

A conveyor belt 6 is located on a scale 7. The scale weighs the conveyor belt together with the component of the mixing material located thereon. The quantity of mixing material that arrives in the mixer from the conveyor belt is thus determined. The feed of one or more additional components, which, for example, arrive in the mixer via a feeding pipe 8 is controlled depending thereon. Additional feeding pipes may also be provided which feed additional components depending on the feed of mixing material, via the conveyor belt 6 to the mixer.

It is thus achieved that the composition of the mixing material in the mixer remains constant.

The mixed material arrives in a container 9 via a discharge passage 5. The container 9 is located on a scale 10. The quantity of mixed material contained in the container 9 is thus determined. The feed of the components of the mixing material is controlled depending on this result. Controlling is done in such a way that there is always at least a predetermined minimum quantity of mixed material in the container 9 and that a maximal quantity is not exceeded. A constant quantity of mixed material is taken out of the container 9 via a pump or screw 11.

In order to avoid that mixing material forms in a funnel shape in the container and that a constant withdrawal of mixing material is not possible anymore in the end, a screw 10 is located close to the bottom of the container 9. This counteracts the formation of a funnel. It is thus ensured that the mixing material can constantly be withdrawn from the container 9.

To avoid unmixing in the container, a stirrer 13 is furthermore provided.

If the container 9 is about to be emptied and if a sufficient quantity of mixing material cannot be fed to the mixer 1, then the performance of the pump or screw 11 with which the mixing material is withdrawn from the container 9 is reduced. What is important is that, after the reduction of the performance, mixing material is once again withdrawn constantly on a smaller level from the container 9, or that it can be withdrawn.

Conversely, the withdrawal can be increased if necessary, when there is a sufficient amount of mixing material available again that can be fed to the mixer.

Thus, a device is provided with which different components of a mixing material can be mixed with each other. Furthermore, the mixed material is passed on in a constant quantity. Thus, it is advantageously ensured that there is always a constant quantity of mixing material available in a subsequent process. As a rule, this is advantageous in an economically efficient production.

Advantageously, the mixer comprises, close to the discharge passage 5, a baffle disc 14 that is mounted in a swiveling manner. Depending on the position of the baffle disc, the mixing material remains in the mixer 1. Thus, the optimal residence time of mixing material in the mixer can be set, depending on the feed of mixing material as well as depending on the withdrawal of mixing material from container 9. The wear in the mixer can thus be minimized.

What is claimed is:

1. A transport device for bulk material comprising:
a mixer;
a feed for bulk material;
a feed for liquid into the mixer; and
a means for withdrawing mixing material from the mixer and transporting it further via pipelines with a pump.

2. The transport device of claim 1 further comprising a means for monitoring the available quantity of mixed material and for controlling the feed of components of the mixing material depending on this monitoring.

3. The transport device of claim 2 further comprising:
a container which the mixed mixing material is placed into;
a scale on which the container is located; and
a means which control the feed of components into the mixer depending on the weight determined by the scale.

4. The transport device of claim 1 comprising:
a container which the mixed mixing material is placed into; and
a means for monitoring the content of the container with a control device by means of which the feed of components of the mixing material is controlled depending on the content of the container.

5. The transport device of claim 4, wherein a screw is preferably arranged on the bottom of the container.

6. The transport device of claim 5, wherein there is a stirring tool present in the container and the container is connected with the discharge passage of the mixer.

7. The transport device of claim 1 further comprising a monitoring and controlling means controlling the composition of the components fed to the mixer.

8. The transport device of claim 7 further comprising a mixture of sand and water located in the transport device.

9. The transport device of claim 8 further comprising a control apparatus to change the pumping power of the pump stepwise depending upon the quantity of pumpable mixing material available, namely advantageously in a container connected with the discharge passage of the mixer.

10. The transport device of claim 1 further comprising:
a weighing belt for feeding bulk material into the mixer;
a pipeline for feeding liquid into the mixer; and
a control device with which the feed of liquid is controlled depending on the weighed result of the weighing belt.

11. The transport device of claim 10, wherein the mixer is placed onto a scale, and a control device is present that is designed such that it controls the feed of components into the mixer depending on the weighed value of the scale.

12. The transport device of claim 11, wherein mixing material is passed on from the bottom of a container to the pump arranged underneath the container.

13. The transport device of claim 12 further comprising a pipeline which is at least one kilometer long and which can be filled with mixing material via the discharge passage of the mixer.

14. The transport device of claim 13 further comprising a baffle disc which can be swiveled into the mixer or out of the mixer.

15. The transport device of claim 14, wherein an inner wall of the mixer has a rubber coating that is preferably sectioned into segments and wherein the segments are bolted onto the inner wall.

16. A transport device for transporting a bulk material comprising:
a mixer;
a first feed for supplying a bulk material to the mixer;
a second feed for supplying a liquid to the mixer, wherein the bulk material and the liquid are mixed into a mixed material;
a container to receive the mixed material from the mixer via a mixer discharge passage;
a pump for removing the mixed material from the container and transporting the mixed material via a pipeline;
a scale to measure the weight of the bulk material; and
a control device to control the amount of the liquid supplied to the mixer based on the weight of the bulk material.

17. The transport device of claim 16 further comprising a control device to control a pumping speed of the pump based on the weight of the bulk material.

18. A transport device for transporting a bulk material comprising:
a mixer;
a first feed for supplying a bulk material to the mixer;
a second feed for supplying a liquid to the mixer, wherein the bulk material and the liquid are mixed into a mixed material;
a container to receive the mixed material from the mixer via a mixer discharge passage;
a pump for removing the mixed material from the container and transporting the mixed material via a pipeline;
a scale to measure the weight of the mixed material inside the container; and
a control device to control the amount of bulk material and liquid supplied to the mixer based on the weight of the mixed material.

19. The transport device of claim 18 further comprising a control device to control a pumping speed of the pump based on the weight of the mixed material.

20. The transport device of claim 19, wherein the bulk material is sand and the liquid is water.
